(19) United States
(12) Patent Application Publication
(10) Pub. No.: US 2008/0031645 A1
(43) Pub. Date: Feb. 7, 2008

(54) IMAGE FORMING DEVICE

(75) Inventor: Takahiro SASAI, Kyoto-shi (JP)

Correspondence Address: MURATA MACHINERY, LTD.;(MURATEC) c/o KEATING & BENNETT LLP, 8180 GREENSBORO DRIVE, SUITE 850, MCLEAN, VA, 22102, US

(73) Assignee: MURATA KIKAI KABUSHIKI KAISHA, Fushimi-ku (JP)

(21) Appl. No.: 11/775,907

(22) Filed: Jul. 11, 2007

(30) Foreign Application Priority Data
Aug. 7, 2006 (JP) 2006-214238

(51) Int. Cl. G03G 15/00; G03G 15/16

(52) U.S. Cl. 399/44; 399/66

(57) ABSTRACT

In an image forming device, when a transfer bias voltage is applied to a contact transfer member under a state in which a recording medium is nipped between a photoconductive drum and the contact transfer member, a toner image on a surface of the photoconductive drum is transferred onto the recording medium. A test voltage is applied to the contact transfer member under a state in which the recording medium is not nipped between the photoconductive drum and the contact transfer member. The transfer bias voltage is determined based on a current value acquired when the test voltage is applied. If a pre-set condition is satisfied, a pre-set adjusting value is added or subtracted.

This application claims priority under 35 U.S.C. 119 to Japanese Patent Application No. 2006-214238, filed on Aug. 7, 2006, which application is hereby incorporated by reference in its entirety.

### BACKGROUND OF THE INVENTION

1. Field of the Invention

The present invention relates to an image forming device of a contact-transfer type including a photoconductive drum and a contact transfer member arranged in contact with the photoconductive drum.

2. Description of the Related Art

In an image forming device of a contact-transfer type, a resistance value of a transfer roller as a contact transfer member changes depending on environmental conditions such as temperature and humidity. In view of such a point, in a conventional art, a test voltage is applied to the transfer roller. Then, based on a current value and temperature at that time, a predetermined function or a look-up table is referred to, and a transfer bias voltage is set.

According to the above-described configuration in the conventional art, regardless of changes in the environmental conditions, an appropriate transfer bias is set, and a good printing quality is achieved.

However, the above-described resistance value of the transfer roller can be changed by not only the changes in the environmental conditions but also other factors. For example, resistance of the transfer roller may increase in a case such as when toner adheres to the transfer roller.

In view of such a problem, a value pre-set in the device (i.e., an offset value) is equally added to the transfer bias voltage set by the function and the look-up table. Accordingly, a transfer defect can be prevented even if the resistance increases.

However, the resistance increase of the transfer roller caused by toner adherence as described above is affected only when the transfer roller is used in a low-temperature and low-humidity environment (in an LL environment), and is hardly affected under other environmental conditions (in a normal-temperature and normal-humidity environment, i.e., in an NN environment, or in a high-temperature and high-humidity environment, i.e., in an HH environment). Accordingly, if the equal offset is added as described above, an excessive high-voltage can be applied to the transfer roller at unnecessary portions thereof. Therefore, further improvements are required.

### SUMMARY OF THE INVENTION

In order to overcome the problems described above, preferred embodiments of the present invention provide an image forming device with the following configuration. That is, the image forming device includes a photoconductive drum and a contact transfer member pressed against the photoconductive drum. When a transfer bias voltage is applied to the contact transfer member under a state in which a recording medium is nipped between the photoconductive drum and the contact transfer member, a toner image on a surface of the photoconductive drum is transferred onto the recording medium. The image forming device further includes a test voltage applying circuit, a current detection circuit, and a transfer bias determining circuit. The test voltage applying circuit applies a test voltage to the contact transfer member under a state in which the recording medium is not nipped between the photoconductive drum and the contact transfer member. The current detection circuit acquires a current value when the test voltage is applied by the test voltage applying circuit. The transfer bias determining circuit determines (calculates) the transfer bias voltage based on the current value acquired by the current detection circuit. After acquiring a value by applying a prescribed procedure to the current value, if a pre-set condition is satisfied, the transfer bias determining circuit determines the transfer bias voltage by adding a pre-set adjusting value to the acquired value or subtracting the pre-set adjusting value from the acquired value.

After acquiring the value by applying the prescribed procedure to the current value, the transfer bias determining circuit may determine the transfer bias voltage by multiplying the pre-set adjusting value instead of adding or subtracting.

In the above-described configuration, the transfer bias voltage can be adjusted within a necessary and sufficient range even in a case in which an impedance of the contact transfer member changes only in a certain environment. Therefore, a good image quality can be reliably achieved in various environments.

In the image forming device, the pre-set condition is defined such that the current value detected by the current detection circuit is preferably within a pre-set range.

Accordingly, the condition can be set with a simple configuration. In addition, it is unnecessary to provide a special sensor, etc. to determine whether or not the condition is satisfied. Therefore, the simple configuration can be achieved.

The image forming device preferably includes the following configuration. The image forming device includes an environment detection device operable to detect at least either temperature or humidity. The pre-set condition is defined such that at least either the temperature or the humidity detected by the environment detection device is within a pre-set range.

In the above-described configuration, by detecting the temperature and/or humidity that greatly affect the impedance of the contact transfer member, it is determined whether or not the condition is satisfied. Therefore, the transfer bias voltage can be appropriately adjusted.

The image forming device preferably includes an operation unit operable to set the adjusting value and the range of the condition.

In the above-described configuration, the adjusting value and the range of the condition can be simply set by using the operation unit.

The image forming device preferably includes the following configuration. That is, at least either the photoconductive drum or a developing unit, which develops an electrostatic latent image on the photoconductive drum into a toner image, can be removably inserted into a main body. When it is detected that a new photoconductive drum or developing unit is attached to the main body, the adjusting value and the condition set by the operation unit are automatically cleared.

In other words, such cases in which the impedance of the contact transfer member changes only in a certain environment can often be solved by changing the photoconductive drum and the developing unit to new ones. In view of this point, by detecting attachment of the new photoconductive drum and developing unit and automatically clearing the adjusting value and/or the condition as described above, a special clearing operation becomes unnecessary, and a burden of maintenance operation can be reduced.

Other features, elements, processes, steps, characteristics and advantages of the present invention will become more apparent from the following detailed description of preferred embodiments of the present invention with reference to the attached drawings.

### BRIEF DESCRIPTION OF THE DRAWINGS

FIG. 1 is an elevation view with a partially sectional view illustrating an overall configuration of a Multi Function Peripheral (MFP) according to a preferred embodiment of the present invention.

FIG. 2 is an enlarged elevation sectional view of a recording unit of the MFP.

FIG. 3 is a schematic view and a block diagram of the MFP.

FIG. 4 is a flowchart of control of the MFP.

FIG. 5 is a sequence diagram illustrating a case in which a test transfer voltage and a transfer bias voltage are applied to a transfer roller when printing.

FIG. 6 is a graph illustrating an example of a transfer feedback function that determines the transfer bias voltage and an offset of the function.

### DETAILED DESCRIPTION OF PREFERRED EMBODIMENTS

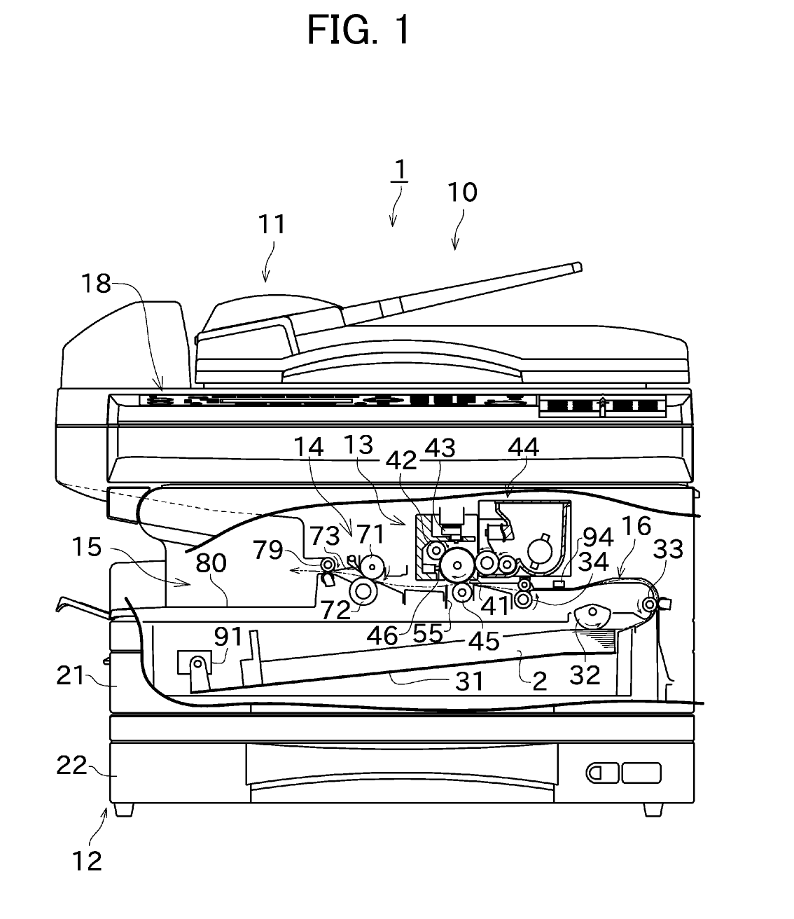

Next, a description will be made of preferred embodiments of the present invention. FIG. 1 illustrates an MFP 1 as an electrophotographic image forming device. The MFP 1 preferably includes a facsimile function, a copier function, and a printer function. An original document scanning unit 11 is arranged on an upper portion of a housing 10 of the MFP 1. An original document to be transmitted by facsimile or to be copied can be placed at the original document scanning unit 11. An operation unit 18 is arranged on a front side of the original document scanning unit 11 (i.e. on a front side in FIG. 1). The operation unit 18 is provided for a user to operate the MFP 1. A touch-panel-type display and various operation buttons such as a numeric keypad and arrow keys are arranged at the operation unit 18. A paper feed unit (a recording medium supply unit) 12 is arranged on a lower portion of the housing 10. The paper feed unit 12 can accommodate stacked papers 2 used as recording mediums. A recording unit 13, a fuser unit 14, and a paper discharge unit 15 are collaterally arranged in a middle portion of the housing 10.

The original document scanning unit 11 includes an auto document feeder and a flatbed. A Charge Coupled Device (CCD) sensor (not shown) scans an original document. The paper feed unit 12 includes two paper feed trays, i.e., an upper tray 21 and a lower tray 22, that can be drawn out towards the front side.

A plurality of papers 2 can be stacked on a plate-shaped flapper 31 pivotably arranged in the upper tray 21. A fan-shaped paper feed roller 32 is arranged above the flapper 31. When an urging spring (not shown) lifts up the flapper 31, and the paper feed roller 32 is driven in a direction indicated by an arrow in FIG. 1, an uppermost paper 2 is separated, picked up one sheet at a time, and transported towards the recording unit 13. A temperature sensor (an environment detection device) 91 operable to detect temperature around the stacked papers 2 is arranged at an appropriate position in the upper tray 21. A thermistor, for example, can be used as the temperature sensor 91. A configuration similar to that of the upper tray 21 is adopted in the lower tray 22.

As illustrated in FIG. 1, a curved-shaped paper transportation path 16 is arranged inside the housing 10 of the MFP 1. The paper transportation path 16 extends from the paper feed unit 12 to the paper discharge unit 15 via the recording unit 13 and the fuser unit 14. In the paper transportation path 16, a feed roller 33 is arranged on a downstream side of the paper feed roller 32. A resist roller 34 is arranged on a further downstream side. A driven roller is arranged opposite the feed roller 33 and the resist roller 34, respectively. Each of the driven rollers is respectively urged against the feed roller 33 and the resist roller 34. In the above-described configuration, the feed roller 33 and the resist roller 34 transport the paper 2 to the recording unit 13 on a downstream side by being rotationally driven and nipping the paper 2 with the respective driven rollers. A paper detection sensor 94 is arranged on a slightly upstream side of the resist roller 34. The paper detection sensor 94 is turned on when detecting the paper 2 that passes through the paper transportation path 16.

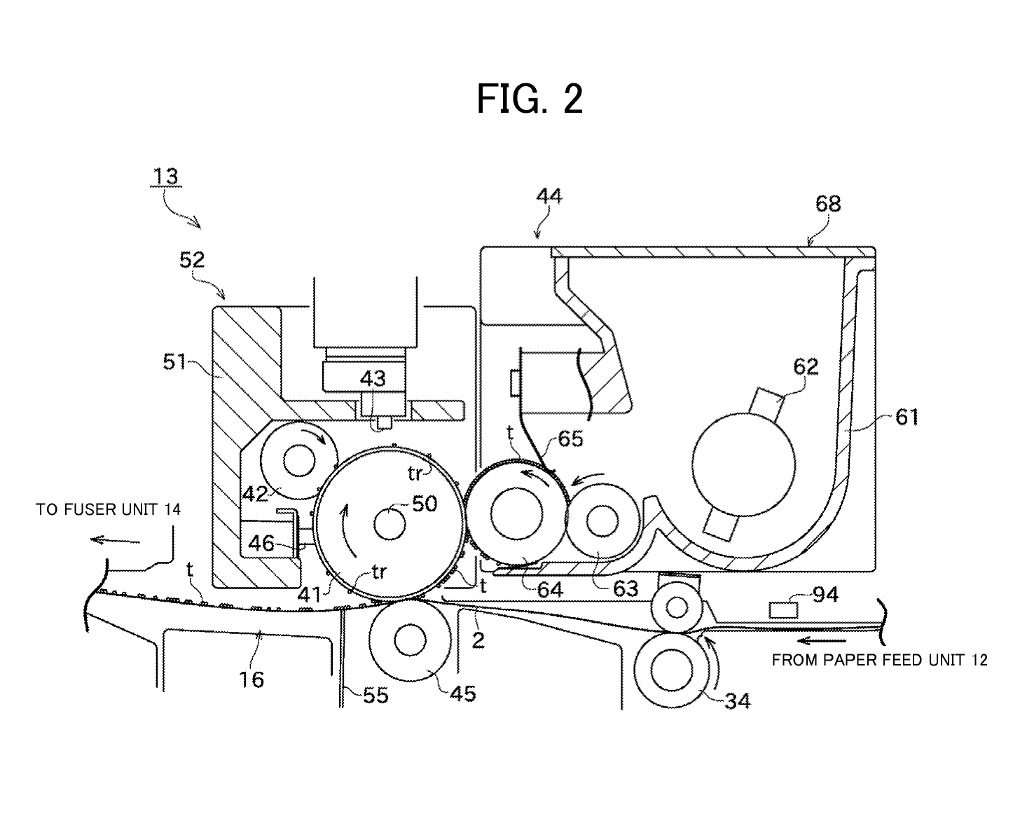

FIG. 2 is an enlarged view of the recording unit 13. As illustrated in FIG. 2, the recording unit 13 as an image forming unit preferably includes a photoconductive drum 41, a charging brush 42, a Light Emitting Diode (LED) head 43, a developing unit 44, a transfer roller 45, and a memory removing brush 46. The components 42-46 are arranged around the photoconductive drum 41.

In the photoconductive drum 41, a rotating shaft 50 is supported preferably on a synthetic-resin-made housing (a frame) 51. An aluminum tube is fixed around the rotating shaft 50. A layer of organic photoreceptor is formed on a peripheral surface of the tube. The charging brush 42 includes a metal shaft and a conductive brush formed on a surface of the metal shaft. A predetermined bias voltage (a charging bias voltage) is applied to the charging brush 42 from a high-voltage power supply (not shown). In the above-described configuration, the photoconductive drum 41 and the charging brush 42 are rotated in a direction indicated by an arrow in FIG. 2, and a surface of the charging brush 42 rubs a peripheral surface (a surface) of the photoconductive drum 41. Thus, the surface of the photoconductive drum 41 is negatively charged uniformly.

The LED head 43 as an exposing unit is arranged on a downstream side of the charging brush 42, i.e., on a downstream side of a rotating direction of the photoconductive drum 41. Hereinafter, the downstream side of the rotating direction of the photoconductive drum 41 will be referred to as a downstream side. A plurality of light emitting diodes are aligned in a paper width direction on the LED head 43. The LED head 43 is arranged such that a light irradiating surface thereof faces the surface of the photoconductive drum 41. The LED head 43 selectively emits light according to image data of a facsimile original document received via a telephone line or to image data scanned at the original document scanning unit 11. As a result, the surface of the photoconductive drum 41 is selectively exposed. Then, charge energy on an exposed portion disappears, and an electrostatic latent image is formed.

The developing unit 44 is arranged on a downstream side of the LED head 43. The developing unit 44 includes a toner container 61 that contains nonmagnetic one-component toner. The developing unit 44 also includes an agitating blade 62 that is rotationally driven inside the toner container 61 to agitate the toner. Further, the developing unit 44 includes a supply roller 63 arranged inside the toner container 61, a developing roller 64 arranged in contact with the supply roller 63, and a regulation blade 65 arranged to make contact with a peripheral surface of the developing roller 64. A predetermined negative bias voltage (a developing unit bias voltage) can be applied to the supply roller 63, the developing roller 64, and the regulation blade 65 from the high-voltage power supply.

In the above-described configuration, the supply roller 63 and the developing roller 64 are rotationally driven such that the rollers 63 and 64 rub each other on a peripheral surface thereof in opposite directions. A leading end of the regulation blade 65 rubs the peripheral surface of the rotationally driven developing roller 64. As a result, the toner inside the toner container 61 is triboelectrificated and adhered to the surface of the developing roller 64. Toner “t” on the surface of the developing roller 64 is adjusted by the regulation blade 65 such that a thickness of the toner “t” will be even, and transported by rotation of the developing roller 64 towards a side of the photoconductive drum 41.

Then, at a portion where the photoconductive drum 41 and the developing roller 64 come close to each other, the toner “t” on the surface of the developing roller 64 is selectively transferred onto the surface of the photoconductive drum 41 only to a portion exposed by the LED head 43. As a result, a toner image is formed on the surface of the photoconductive drum 41.

The transfer roller 45 is arranged on a downstream side of the developing unit 44. The transfer roller 45 is positioned on an opposite side of the photoconductive drum 41 with the paper 2 (the paper transportation path 16) interposed therebetween. The transfer roller 45 is urged by an urging spring (not shown) in a direction that comes close to the photoconductive drum 41. Accordingly, the paper 2 transported to the recording unit 13 can be nipped between the photoconductive drum 41 and the transfer roller 45. According to the preferred embodiments of the present invention, the transfer roller 45 preferably is composed of conductive urethane foam (the conductive urethane foam may be either ion conductive or electron conductive). A predetermined positive bias voltage (a transfer bias voltage) can be applied to the transfer roller 45 from the high-voltage power supply.

The toner image formed on the surface of the photoconductive drum 41 is moved by rotation of the photoconductive drum 41 such that the toner image comes close to a nip portion, and transferred at the nip portion onto the paper 2 by an electric field attraction force. However, the toner “t” in the toner image is not entirely transferred onto the paper 2. The toner which has not been transferred remains as residual toner (untransferred toner) “tr” on the surface of the photoconductive drum 41.

The memory removing brush 46 is arranged on a downstream side of the transfer roller 45. A leading end of a brush of the memory removing brush 46 makes contact with the surface of the photoconductive drum 41. A predetermined positive bias voltage (a memory removing bias voltage) is applied to the memory removing brush 46. The residual toner “tr” on the surface of the photoconductive drum 41 is uniformly spread (dispersed) on the surface of the photoconductive drum 41 by the memory removing brush 46. Since the memory removing bias voltage is applied to the memory removing brush 46, the residual toner “tr” can be dispersed more effectively.

Accompanying the rotation of the photoconductive drum 41, the residual toner “tr” spread on the surface of the photoconductive drum 41 as described above passes the charging brush 42 on the downstream side, and further passes the LED head 43. The residual toner “tr” on the portion exposed by the LED head 43 is transferred onto the paper 2 along with the toner “t” from the developing roller 64. The residual toner “tr” on an unexposed portion is transferred onto the surface of the developing roller 64 by a potential difference and collected by the developing unit 44.

In the above-described configuration of the recording unit 13, at least the photoconductive drum 41, the charging brush 42, and the memory removing brush 46 are accommodated in the housing 51 and can be integrally handled as a photoconductive drum unit 52. Moreover, at least the agitating blade 62, the supply roller 63, the developing roller 64, and the regulation blade 65 are attached to the synthetic-resin-made toner container 61 and can be integrally handled as a toner cartridge 68. The photoconductive drum unit 52 and the toner cartridge 68 can be removably inserted into the MFP 1, and changed if required.

The toner image transferred onto the paper 2 at the recording unit 13 as described above has its electronic potential removed by an electricity removing brush 55. The electricity removing brush 55 is arranged adjacent to the transfer roller 45. The paper 2 is transported to the fuser unit 14 on the downstream side in the paper transportation path 16 by the rotation of the photoconductive drum 41.

As illustrated in FIG. 1, the fuser unit 14 includes a heat roller 71 and a pressing roller 72. The heat roller 71 preferably includes a heater (such as a halogen lamp) and is rotated. The pressing roller 72 is arranged opposite the heat roller 71. The pressing roller 72 is pressed against the heat roller 71 by an urging spring (not shown). When the paper 2 passes between the heat roller 71 and the pressing roller 72, the toner “t” in the toner image is melted and fixed to the paper 2 by high heat of the heat roller 71 and pressure of the pressing roller 72. A separating claw 73 is provided in the fuser unit 14. The separating claw 73 prevents the paper 2 from sticking to and winding around the heat roller 71.

The discharge unit 15 includes a discharge roller 79 and a discharge tray 80. The discharge roller 79 is rotationally driven. The discharge tray 80 accommodates the discharged papers 2. The paper 2 transported from the fuser unit 14 is nipped between the discharge roller 79 and a driven roller arranged opposite the discharge roller 79, and discharged onto the discharge tray 80.

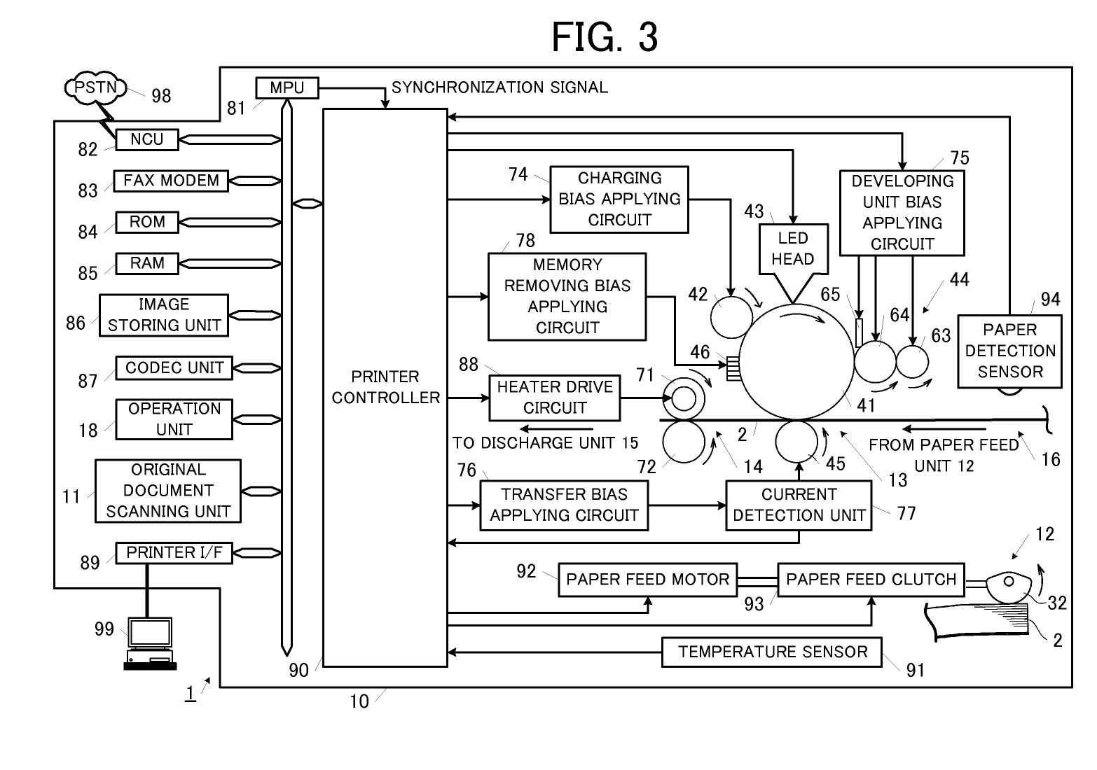

Next, with reference to a schematic view and a block diagram of FIG. 3, a description will be made of an electrical configuration of the MFP 1. As illustrated in FIG. 3, the MFP 1 according to the preferred embodiments of the present invention preferably includes a Micro Processing Unit (MPU) 81, a Read Only Memory (ROM) 84, and a Random Access Memory (RAM) 85, both used as a storage device. The MPU 81 performs basic arithmetic processing. The ROM 84 and the RAM 85 store programs and various data.

The MFP 1 further includes an image storing unit 86, a Network Control Unit (NCU) 82, a FAX modem 83, and a codec unit 87. The image storing unit 86 stores and temporarily memorizes image data acquired by the original document scanning unit 11. The NCU 82 connects to Public Switched Telephone Networks (PSTN) 98. The FAX modem 83 is a modem that converts an audio signal and a data message into each other. The codec unit 87 compresses and/or expands image data by a publicly known compression method such as the Modified Huffman (MH), the Modified Read (MR), and the Modified MR (MMR).

Further, the MFP 1 includes a printer interface 89 through which the MFP 1 can be connected to a personal computer 99 as an external device. Furthermore, the MFP 1 includes a printer controller (a test voltage applying circuit and/or a transfer bias determining circuit) 90. The printer controller 90 can control the paper feed unit 12, the recording unit 13, the fuser unit 14, and the discharge unit 15, etc. An appropriate synchronization signal is input from the MPU 81 into the printer controller 90 along with various commands. Thus, a facsimile function, a printer function, and a copier function can be performed.

The temperature sensor 91 is connected to the printer controller 90. Information on temperature around the paper feed unit 12 can be input into the printer controller 90. Moreover, a paper feed motor 92 and a paper feed clutch 93 are connected to the printer controller 90. The paper feed motor 92 rotationally drives the paper feed roller 32. The paper feed clutch 93 is arranged between a drive shaft of the paper feed motor 92 and the paper feed roller 32. Thus, the printer controller 90 can control to drive and stop the paper feed motor 92 and to connect and disconnect the paper feed clutch 93. Moreover, the paper detection sensor 94 is connected to the printer controller 90. The paper detection sensor 94 can input information on whether or not the paper 2 is passing. Such information can be input into the printer controller 90.

A charging bias applying circuit 74 is connected to the printer controller 90. The required charging bias voltage can be applied to the charging brush 42. The printer controller 90 is connected to the LED head 43 of the recording unit 13 and controls light emission of the LED head 43. Further, a developing unit bias applying circuit 75 is connected to the printer controller 90. The required developing unit bias voltage can be applied to the supply roller 63, the developing roller 64, and the regulation blade 65 of the developing unit 44.

A transfer bias applying circuit 76 is connected to the printer controller 90. The required transfer bias voltage can be applied to the transfer roller 45. Further, a current detection unit (a current detector) 77 as a current sensor is connected to the transfer roller 45. The current detection unit 77 detects a current flowing to the transfer roller 45. Information on a current value can be input into the printer controller 90. Although details of the current detection unit 77 are not illustrated, the current detection unit 77 can include, for example, a current detection resistor, a differential amplifier, and an analog to digital converter (an A/D converter). The current detection resistor is tandemly-arranged between the transfer roller 45 and the transfer bias applying circuit 76. The differential amplifier detects a potential difference between both end portions of the current detection resistor. The A/D converter converts signals from the differential amplifier from analog to digital or from digital to analog.

Further, a memory removing bias applying circuit 78 is connected to the printer controller 90. The required memory removing bias voltage can be applied to the memory removing brush 46. Furthermore, a heater drive circuit 88 is connected to the printer controller 90. The heater drive circuit 88 can control a heater provided inside the heat roller 71 of the fuser unit 14.

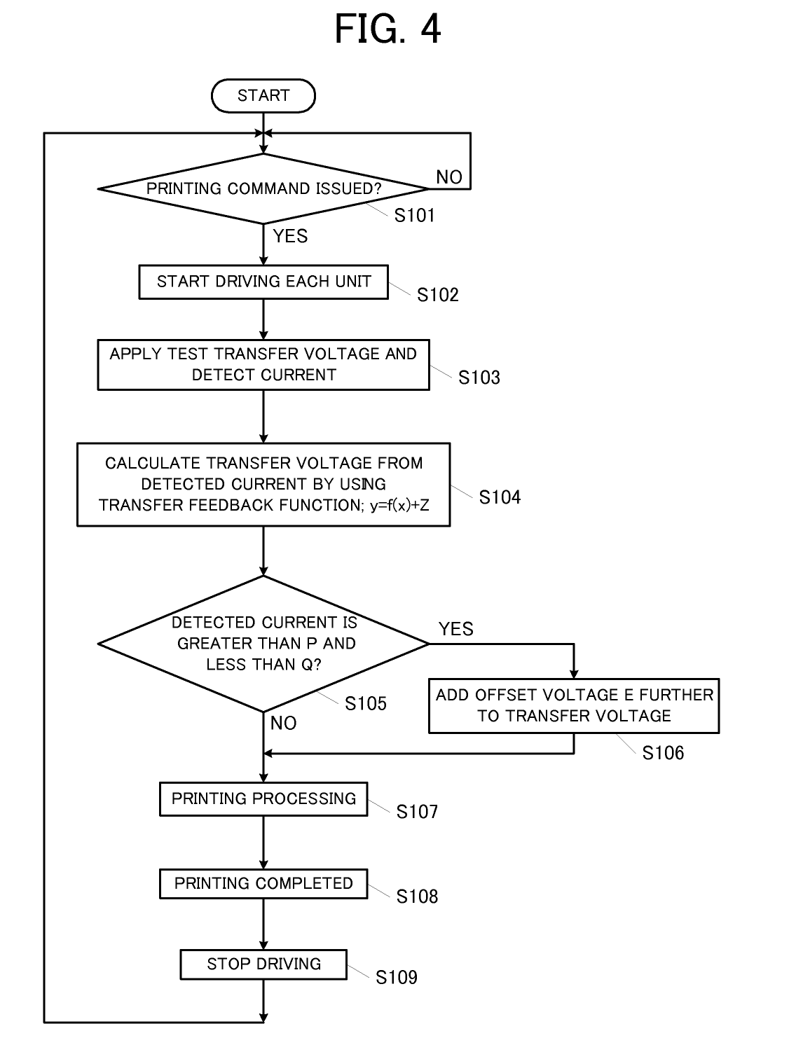

Next, with reference to a flowchart in FIG. 4, a description will be made of control of the printer controller 90. When processing is started, the printer controller 90 waits for a printing command from the MPU 81 first (at step 101). The MPU 81 generates the printing command when the MFP 1 receives a facsimile document via a telephone line, when a copying instruction is issued from the operation unit 18, or when a printing instruction is issued from the personal computer 99. When the printing command is input into the printer controller 90, the printer controller 90 starts driving a motor (including the paper feed motor 92) at each unit that drives the MFP 1 (at step 102).

After starting to drive each unit, the printer controller 90 immediately controls the transfer bias applying circuit 76. Then, a test transfer voltage (a test voltage) is applied to the transfer roller 45 for a predetermined time (at step 103). The test transfer voltage is applied in advance to the transfer roller 45 in order to determine magnitude of the voltage (the transfer bias voltage) to be applied to the transfer roller 45 when the toner image is transferred onto the paper 2. The test transfer voltage is, for example, a constant positive voltage of approximately 1 kV.

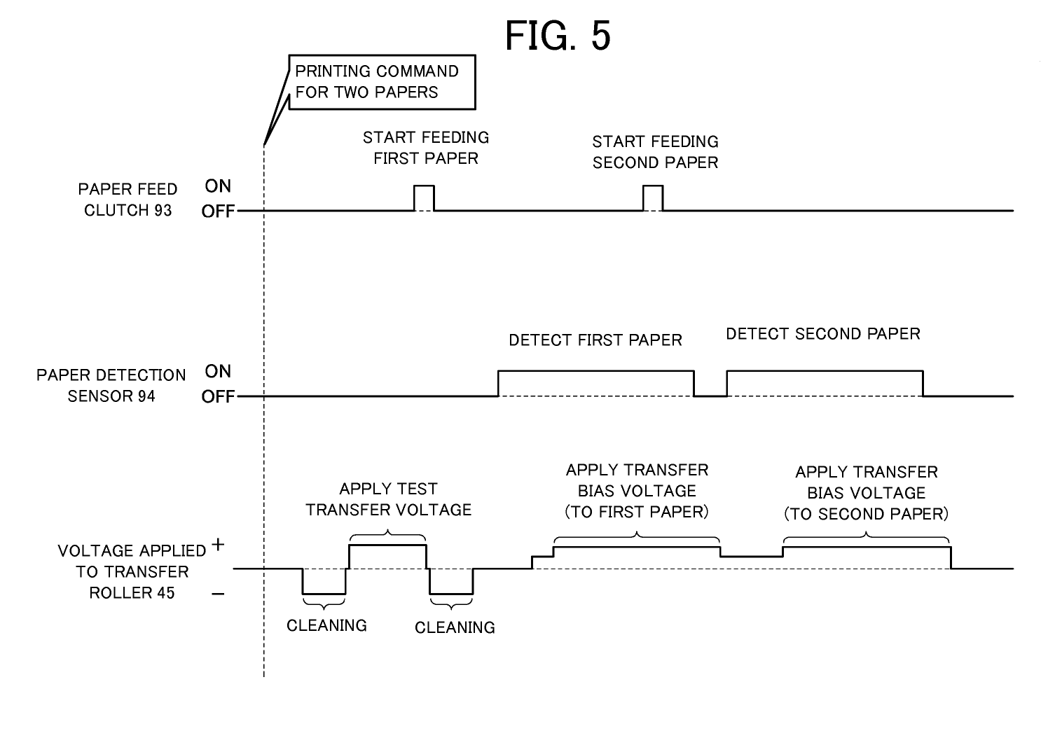

FIG. 5 illustrates a sequence diagram of a case in which the printing command is issued. As illustrated in FIG. 5, the test transfer voltage is applied before the paper feed clutch 93 is turned on. Accordingly, the test transfer voltage is applied at a time when the paper 2 has not been supplied to the recording unit 13 and has not been nipped between the photoconductive drum 41 and the transfer roller 45. In addition, a constant negative voltage (a cleaning voltage) is applied for a predetermined time before and after the test transfer voltage is applied to the transfer roller 45.

Then, at a later point of time when the test transfer voltage is being applied, for example, an intensity of the current flowing to the transfer roller 45 can be detected and acquired by the current detection unit 77. The detection (sampling) of the current intensity by the current detection unit 77 may be carried out once or several times.

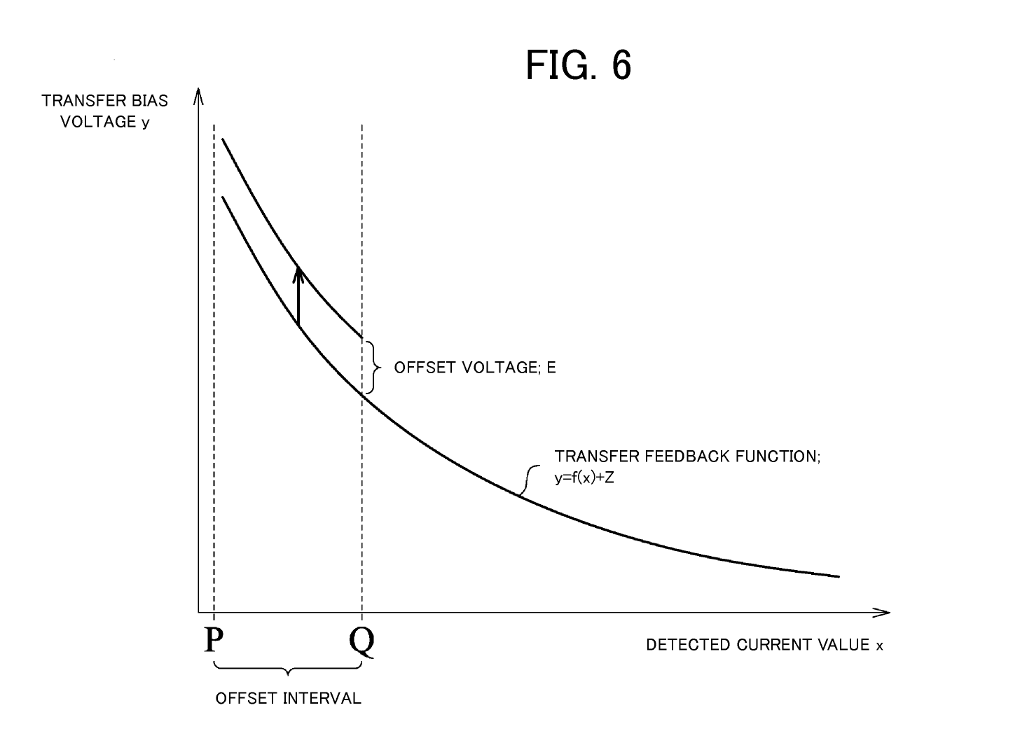

Next, the transfer bias voltage is determined from the acquired current value (at step 104 in FIG. 4). The voltage can be calculated by using a function (a transfer feedback function) illustrated in FIG. 6, for example. According to the transfer feedback function, the smaller the detected current value is (i.e., the greater the resistance of the transfer roller 45 is), the more the transfer bias voltage to be applied gradually increases.

According to the preferred embodiments of the present invention, the transfer feedback function is used as a high-order polynomial function. The polynomial function is calculated in advance based on experimental data. The polynomial function is stored in an appropriate storage device of the printer controller 90, or in the ROM 84 and RAM 85, etc., on a main body side.

The printer controller 90 determines the transfer bias voltage by applying the current value to the above-described transfer feedback function. Then, the printer controller 90 examines whether or not the detected current value is within a pre-set range of the current value (i.e., whether or not the detected current value is greater than P and less than Q) (at step 105). The range of the current value (P, Q) is pre-set when a service person operates the numeric keypad etc. at the operation unit 18, and is stored in the RAM 85. If the detected current value is within the above-described range, an offset voltage E as a pre-set adjusting value is added (an offset correction at step 106) to the transfer bias voltage acquired at step 104. The offset voltage E is also pre-set when the service person operates the operation unit 18, and is stored in the RAM 85. If the detected current value is not within the above-described range, processing at step 106 is skipped.

After the determination of the transfer bias voltage and the offset correction, printing processing is carried out (at step 107). In the printing processing, the transfer bias voltage acquired after the offset correction carried out according to necessity is applied to the transfer roller 45. As illustrated in FIG. 5, the transfer bias voltage is applied at a time when each paper 2 passes the recording unit 13. The above-described time is calculated based on an input time of a paper detection signal from the paper detection sensor 94.

When the printing processing is completed (at step 108), the drive at each unit is stopped (at step 109). Then, returning to step 101, the printing command from the MPU 81 is waited.

Upon an initial shipment of the MFP 1 with the above-described configuration, the current value range P, Q, and the offset voltage E, which are parameters related to steps 105 and 106, are pre-set to zero. Accordingly, when normally using the MFP 1 after the initial shipment, the processing at step 106 in FIG. 4 is not carried out.

If the MFP 1 is used in a cold area (i.e., in the LL environment), and the impedance increases when the toner is deposited to the transfer roller 45, the transfer bias voltage is greatly lacking. As a result, an image quality is degraded by a transfer defect of the toner image to the paper 2. In such a case, the service person asked by the user for adjustment can operate the operation unit 18 accordingly and set the values of P, Q, and the appropriate offset voltage E.

Thus, the range of the current value generally detected when the test transfer voltage is applied in the environment of the cold area can be set as the values P and Q. An appropriate positive value is also set as the offset voltage E. Accordingly, after the above-described setting, the transfer bias voltage to which the offset voltage E is added in the processing at step 106 can be applied to the transfer roller 45. Therefore, the transfer defect can be prevented, and a printing quality can be improved. In addition, when the user moves and uses the MFP 1 in a warm area (in the NN environment or the HH environment), since the current value to be detected departs from the range defined by P and Q, the adding processing of the offset voltage E (step 106) is not carried out. Thus, an excessive transfer bias voltage can be avoided.

As described above, the MFP 1 according to the preferred embodiments of the present invention includes the photoconductive drum 41 and the transfer roller 45 pressed against the photoconductive drum 41. Since the transfer bias voltage is applied to the transfer roller 45 under a state in which the paper 2 is nipped between the photoconductive drum 41 and the transfer roller 45, the toner image on the surface of the photoconductive drum 41 can be transferred onto the paper 2. Moreover, the printer controller 90 applies the test voltage to the transfer roller 45 via the transfer bias applying circuit 76 under a state in which the paper 2 is not nipped between the photoconductive drum 41 and the transfer roller 45. The printer controller 90 acquires the current value by the current detection unit 77 when applying the test voltage, and determines the transfer bias voltage based on the detected current value. Then, after applying a procedure of the transfer feedback function described in FIG. 6 to the detected current value, the printer controller 90 determines the transfer bias voltage by adding the offset voltage E if the pre-set condition is satisfied.

Accordingly, by adding the offset voltage E only when the necessary and sufficient condition is satisfied, the transfer bias voltage can be adjusted in various environments and under various conditions. Therefore, a good printing quality can be reliably achieved.

Moreover, according to the preferred embodiments of the present invention, the pre-set condition is defined that the current value detected by the current detection unit 77 is within the range defined by the pre-set parameters P and Q.

Accordingly, the condition can be set with the simple configuration. In addition, since it is unnecessary to provide a special sensor, etc., to determine whether or not the condition is satisfied, the simple configuration can be achieved.

Further, in the MFP 1 according to the preferred embodiments of the present invention, the current value range P, Q, and the offset voltage E can be set by the operation unit 18.

Therefore, the parameters P, Q, and E can be simply set by using the operation unit 18.

Furthermore, the offset voltage E may be subtracted instead of adding. Instead of adding or subtracting the offset voltage E, the offset voltage E may be multiplied by an appropriate magnification (such as, about 1.05× or about 0.90×). In this configuration, effect similar to that of the above-described configuration can be achieved.

Alternatively, as the pre-set condition, the temperature detected by the temperature sensor 91 may be within range defined by pre-set parameters. Moreover, in place of the temperature sensor 91 (or along with the temperature sensor 91), a humidity sensor may be provided, and detected humidity (a combination of temperature and humidity) may be within pre-set range. In such a configuration, by detecting the temperature and humidity, which has a great affect on the impedance of the transfer roller 45, a determination can be made whether or not the condition is satisfied. Therefore, the transfer bias voltage can be adjusted more appropriately.

Alternatively, the P, Q, and E may be automatically set to zero when it is detected that the photoconductive drum unit 52 and the toner cartridge 68 have been changed to new ones. As a specific example, the following configuration may be applied. That is, a fuse is provided in the photoconductive drum unit 52 and the toner cartridge 68, and when the photoconductive drum unit 52 and the toner cartridge 68 are attached to the housing 10, the fuse is connected to a circuit on a main body side. The circuit on the main body side examines whether or not the current is flowing through the fuse. When the current is flowing, it is determined that the new photoconductive drum unit 52 and the new toner cartridge 68 have been attached. Then, the parameters P, Q, and E are re-set to zero, and an overcurrent is applied to the fuse and melts down the fuse.

Accordingly, a case in which the transfer bias voltage has to be offset only within partial range of the detected current value can often be solved by changing the photoconductive drum unit 52 and the toner cartridge 68 to new ones. Therefore, by detecting the attachment of the new photoconductive drum unit 52 and toner cartridge 68, the parameters P, Q, and E are automatically re-set, and the partial offset of the transfer bias voltage is not carried out. Thus, the re-setting operation by the service person may be omitted, and maintenance operation can be reduced.

The above-described preferred embodiments may be modified as described below.

In addition to the above described configuration in which the transfer bias voltage is preferably offset only when the current value satisfies the pre-set condition, a function in which the transfer bias voltage is equally offset may be provided. In other words, in addition to the setting of the parameters P, Q, and E, a value acquired from the transfer feedback function “f(x)+Z” may be changed by the operation of the operation unit 18.

As a contact transfer member, in place of the transfer roller 45 described in the above preferred embodiments, a transfer belt may be used, for example.

As a recording medium, in place of the paper 2, an overhead projector sheet (an OHP sheet) or an envelope etc. may be used. Moreover, it is preferable to change the transfer feedback function illustrated in FIG. 6 according to a thickness and a material quality of the recording medium.

The transfer feedback function illustrated in FIG. 6 is an example, and the function may be varied according to conditions. Other than the polynomial function, the transfer bias function may be used as a logarithmic function, hyperbolic function, an irrational function, or a composite function of the polynomial function, the logarithmic function, the hyperbolic function, and the irrational function. Moreover, instead of determining the transfer bias voltage by using a function, a table, for example, may be used to determine the transfer bias voltage.

According to the above-described preferred embodiments of the present invention, both the lower limit P and the upper limit Q can be set as the range of the current value, however, only one of the limits may be set instead. Further, by setting a plurality of offset intervals such as between P and Q, and between R and S, the offset voltage, etc. may be set according to each of the offset intervals.

The processing and the control illustrated in FIG. 4 may be carried out by the MPU 81, for example, in place of the printer controller 90.

The recording unit 13 described above as an example may be applied not only to the MFP 1 but also to a facsimile machine, a copier, and a printer, etc.

While the present invention has been describedwith respect to preferred embodiments thereof, it will be apparent to those skilled in the art that the disclosed invention may be modified in numerous ways and may assume many embodiments other than those specifically set out and described above. Accordingly, the appended claims are intended to cover all modifications of the present invention that fall within the true spirit and scope of the present invention.

What is claimed is:

1. An image forming device comprising:
a photoconductive drum;
a contact transfer member arranged to be pressed against the photoconductive drum and make contact with the photoconductive drum;
a test voltage applying circuit arranged to apply a test voltage to the contact transfer member under a state in which a recording medium is not nipped between the photoconductive drum and the contact transfer member;
a current detection circuit arranged to acquire a current value when the test voltage is applied by the test voltage applying circuit; and
a transfer bias determining circuit arranged to determine a transfer bias voltage based on the current value acquired by the current detection circuit; wherein
a toner image on a surface of the photoconductive drum is transferred onto the recording medium when the transfer bias voltage is applied to the contact transfer member under a state in which the recording medium is nipped between the photoconductive drum and the contact transfer member; and
after applying a prescribed procedure to the current value, the transfer bias determining circuit determines the transfer bias voltage by adding or subtracting a pre-set adjusting value if a pre-set condition is satisfied.

2. The image forming device according to claim 1, wherein the pre-set condition is defined to be that the current value detected by the current detection circuit is within a pre-set range.

3. The image forming device according to claim 2, further comprising an operation unit operable to set the adjusting value and the range of the condition.

4. The image forming device according to claim 3, wherein at least one of the photoconductive drum or a developing unit, which develops an electrostatic latent image on the photoconductive drum into a toner image, can be removably inserted into a main body, and when attachment of a new photoconductive drum or a new developing unit to the main body is detected, the adjusting value and the condition set by the operation unit are automatically cleared.

5. The image forming device according to claim 1 further comprising an environment detection device operable to detect at least either temperature or humidity, wherein the pre-set condition is defined to be that at least either the temperature or the humidity detected by the environment detection device is within a pre-set range.

6. The image forming device according to claim 5, further comprising an operation unit operable to set the adjusting value and the range of the condition.

7. The image forming device according to claim 6, wherein at least either the photoconductive drum or a developing unit, which develops an electrostatic latent image on the photoconductive drum into a toner image, can be removably inserted into a main body, and when attachment of a new photoconductive drum or a new developing unit to the main body is detected, the adjusting value and the condition set by the operation unit are automatically cleared.

8. An image forming device comprising:
a photoconductive drum;
a contact transfer member arranged to be pressed against the photoconductive drum and make contact with the photoconductive drum;
a test voltage applying circuit arranged to apply a test voltage to the contact transfer member under a state in which a recording medium is not nipped between the photoconductive drum and the contact transfer member;
a current detection circuit arranged to acquire a current value when the test voltage is applied by the test voltage applying circuit; and
a transfer bias determining circuit arranged to determine a transfer bias voltage based on the current value acquired by the current detection circuit; wherein
a toner image on a surface of the photoconductive drum is transferred onto the recording medium when the transfer bias voltage is applied to the contact transfer member under a state in which the recording medium is nipped between the photoconductive drum and the contact transfer member; and
after applying a prescribed procedure to the current value, the transfer bias determining circuit determines the transfer bias voltage by multiplying a pre-set adjusting value if a pre-set condition is satisfied.

9. The image forming device according to claim 8, wherein the pre-set condition is defined to be that the current value detected by the current detection circuit is within a pre-set range.

10. The image forming device according to claim 9, further comprising an operation unit operable to set the adjusting value and the range of the condition.

11. The image forming device according to claim 10, wherein at least one of the photoconductive drum or a developing unit, which develops an electrostatic latent image on the photoconductive drum into a toner image, can be removably inserted into a main body, and when attachment of a new photoconductive drum or a new developing unit to the main body is detected, the adjusting value and the condition set by the operation unit are automatically cleared.

12. The image forming device according to claim 8 further comprising an environment detection device operable to detect at least either temperature or humidity, wherein the pre-set condition is defined to be that at least either the temperature or the humidity detected by the environment detection device is within a pre-set range.

13. The image forming device according to claim 11, further comprising an operation unit operable to set the adjusting value and the range of the condition.

14. The image forming device according to claim 13, wherein at least either the photoconductive drum or a developing unit, which develops an electrostatic latent image on the photoconductive drum into a toner image, can be removably inserted into a main body, and when attachment of a new photoconductive drum or a new developing unit to the main body is detected, the adjusting value and the condition set by the operation unit are automatically cleared.
